(19) United States
(12) Patent Application Publication
(10) Pub. No.: US 2017/0118992 A1
(43) Pub. Date: May 4, 2017

(54) CALCIUM INFUSED COMPOUND FOODSTUFFS TARGETED FOR CONSUMPTION BY AND EXTERMINATION OF SPECIFIC RODENT SPECIES

(71) Applicant: Douglas B. Robinson, Pullman, WA (US)

(72) Inventor: Douglas B. Robinson, Pullman, WA (US)

(21) Appl. No.: 15/336,718

(22) Filed: Oct. 27, 2016

Related U.S. Application Data
(60) Provisional application No. 62/247,579, filed on Oct. 28, 2015.

(51) Int. Cl. A01N 59/06; A23K 20/24; A23K 50/50; A01N 25/00

(52) U.S. Cl. CPC A01N 59/06; A01N 25/004; A23K 20/24; A23K 50/50

(57) ABSTRACT

A rodenticide compound comprising a calcium infused bait targeted for consumption by a specific rodent species. The compound causes rodents to ingest calcium at a lethal rate. Each food product is tailored to the usual diet of the targeted rodent species. The selected food product is infused with calcium, usually in the form of calcium carbonate, such that the calcium accounts for at least twenty percent of the combined weight of the selected food product and calcium compound.

### CLAIM OF PRIORITY TO PROVISIONAL APPLICATION (35 U.S.C. §119(e))

This Non-provisional patent application claims priority, under 35 U.S.C. §119(e), from provisional patent Application No. 62/247,579, filed Oct. 28, 2016. The 62/247,579 application is incorporated herein by reference.

### FIELD OF THE INVENTION

The present invention relates to calcium infused compound foodstuffs targeted for consumption by and extermination of specific rodent species. More specifically, the invention discloses a rodenticide compound comprising foodstuffs consumed by specific rodents, such as rats, mice, voles, gophers and the like, infused with sufficient calcium to cause the death of the rodent.

### BACKGROUND OF THE INVENTION

Rodenticides used and in use include: ANTU, α-Naphthylthiourea (C₁₁H₁₀N₂S), an organosulfur compound; arsenic, such as diarsenic trioxide (As₂O₃); barium carbonate (BaCO3), also known as “witherite”; Bromethalin (C₁₄H₇Br₃F₃N₃O₄), a central nervous system poison; calciferols (vitamins D), such as cholecalciferol, or vitamin D₃ (C₂₇H₄₄O), and ergocalciferol, or vitamin D₂ (C₂₈H₄₄O); Crimidine, 2-Chloro-N,N,6-trirnethylpyrimidin-4-amine (C₇H₁₀ClN₃), convulsant poison; Gliftor, 1,3-Difluoro-2-propanol (C₃H₆F₂O), a metabolic poison; Endrin (C₁₂H₈C₁₆O), an organochloride; Fluoroacetamide (C₂H₄FNO); Phosacetim (C₁₄H₁₃C₁₂N₂O₂PS), a toxic organophosphate compound; Pyrinuron, or Pyriminil or Vacor (C₁₃H₁₂N₄O₃); scilliroside (C₃₂H₄₄O₁₂); sodium fluoroacetate, or “1080” (FCH₂CO₂Na); strychnine (C₂₁H₂₂N₂O₂), a crystalline alkaloid; Tetramethylenedisulfotetramine, or “TETS” (C₄H₈N₄O₄S₂), thallium(I) sulfate (T₁₂SO₄), or thallous sulfate, the sulfate salt of thallium; Warfarin (C₁₉H₁₆O₄), an anticoagulant; and Zinc phosphide (Zn₃P₂). Most of these compounds have a significant disadvantage of being potentially harmful to humans or to animals that consume the compound or the rodent that has consumed it.

Of the rodenticides listed above, the vitamin D calciferols, cholecalciferol (D₃) and ergocalciferol (D₂), are notable, because they are described as usually safe around humans and non-target animals. U.S. Pat. No. 5,151,416 to DeLuca states that these vitamin D rodenticides do not have secondary toxicity to non-target animals or humans, because they do not survive for long periods and are rapidly metabolized by the target rodent. See DeLuca, at col. 1, lines 35 through 52. DeLuca also states that the more concentrated hydroxylated vitamin D rodenticides create “even less of an environmental problem”, because only small amounts are required. Id., at lines 52 through 54. DeLuca disclosed a vitamin D rodenticide compound with calcium that produced faster rodent extermination than vitamin D alone. Id., Table 1, and col. 3, lines 7 through 59. DeLuca discloses a compound with vitamin D₃ at 5 parts per million and 3% calcium. DeLuca asserted that testing showed that the 5 ppm vitamin D₃ and 3% calcium compound enhanced the toxicity of the vitamin D. Id., at col. 1, line 62 through col. 2, line 2. However, DeLuca believed that calcium only enhanced the toxic effect of the vitamin D and the calcium was, itself, not toxic to rodents. Id., at col. 1, lines 60 through 62 (rats naturally have “high calcium diets”), and col. 3, lines 34 through 53 (normal calcium diet about 0.5%, so 1% to 3% is high, but more than 3% “unnecessary to achieve the desired results”). Although DeLuca claims to reduce the problem of threats to non-target animals and the environment from vitamin D rodenticides, as a result of decreasing the amount of vitamin D₃ required, DeLuca does not solve the problem.

Another disadvantage of conventional rodenticides is that their use in food production may result in a product that cannot lawfully be labeled as “organic”. This can be very harmful to producers, whose products depend on such certification, when rodent infestations pose a dilemma between lost production to rodents or lost certification, both of which reduce profitability.

There is currently no effective control for these destructive pests other than rodenticides that pose threats to humans, non-target animals, and the environment.

What is needed is a rodenticide that is effective against rodents, but not toxic to humans or to non-target animals that consume the rodenticide itself or eat rodents that have consumed the rodenticide. Also needed is a rodenticide that is recognized as safe for use in the production of organic labeled products.

### SUMMARY OF THE INVENTION

The present invention overcomes these problems by providing a rodenticide that is not toxic to humans or non-target animals and is recognized as safe for use in the production of organic labeled products.

The invention is a rodenticide compound comprising a calcium infused bait targeted for consumption by specific rodent species. The invention causes rodents to ingest calcium carbonate at a lethal rate. The high rate of calcium ingestion provides the lethal effect and eliminates the nuisance rodent quickly and effectively. The invention utilizes a variety of foodstuffs blended using different formulas to target different species of rodents, particularly rats, mice, voles, and gophers. Each food product is tailored to the usual diet of the particular rodent, thereby increasing its effectiveness. The selected food product is infused with calcium, usually in the form of calcium carbonate, such that the calcium accounts for at least twenty percent of the combined weight of the selected food product and calcium compound.

The invention is entirely non-toxic and harmless if consumed by non-rodent mammals and birds. It is harmless to children and domestic pets. This makes the application of the product simple, economical and safe.

Unlike other rodenticides, if a rodent that has ingested the invention is, itself, consumed by a predator, such as a hawk, owl or cat, it is harmless to the predator.

The invention provides a safe, non-toxic method of in-ground application for the control of gophers. There is no danger of food crops absorbing poisons or harmful chemicals, since the active ingredient of the invention, calcium in the form of calcium carbonate and calcium bicarbonate, has been recognized as safe and appropriate for use in the production of organic label eligible food crops. In fact, calcium carbonate is used as a soil amendment to lower the pH of acidic soils and improve crop yields. Any residue from the invention left in or on the soil is harmless, and potentially beneficial.

The invention can be made available to the target rodent without the need to use costly bait stations, designed to prevent non-target animals from getting the baited poison, thereby making it simple and cost effective to use. For example, the invention can be presented for consumption by voles safely and simply by placing the calcium infused foodstuff in a recycled plastic juice or drink bottles, from which the gopher can retrieve it. If non-rodent animals find and consume the calcium infused foodstuff, they will not be harmed. If predators, such as domestic cats and dogs, consume the calcium infused foodtuff or eat a rodent that has consumed it, the predator will not be harmed. Moreover, for the same reasons, the invention can be used in crowded urban areas where rat populations are exploding without any significant precautions and without any danger to public health or safety.

### BRIEF DESCRIPTION OF THE DRAWING

FIG. 1 depicts a kernel of wheat with the rodenticide of the present invention.

### DETAILED DESCRIPTION

The invention comprises a food product that is included in the usual and/or preferred diet of the target rodent. This may include seeds of various kinds, grains, either whole or processed, dried fruits, nuts and/or nut meats of various kinds, and honey or other sweeteners. The food product is infused with finely powdered calcium carbonate, calcium bicarbonate, or other finely powdered substance that is predominately calcium in composition. To assist in adhering the fine calcium powder to the food product, vegetable, seed or nut derived oil may be applied to some or all of the food product. Multiple layers of calcium may be applied to the food product by additional coats of oil and calcium. The calcium infused food product should have at least twenty percent calcium, by weight, of the combined weight of the food product and calcium. Preferably, the calcium infused food product should have thirty percent calcium. The object is to provide an attractive food to the target rodent and infuse that food with sufficient quantities of calcium to render the food lethal to the rodent. At very low levels, for example, below five percent, by weight, of the foodstuff and calcium compound, the rodent will not ingest enough calcium to produce a lethal effect within a reasonable time. Even at calcium rates above five percent, the lethal effect of the calcium may not exterminate the rodent within a reasonable time. More calcium will produce a more lethal and faster acting infusion. It has been found that calcium in amounts greater than twenty percent, by weight, of the foodstuff and calcium compound, produces a lethal result within a reasonable time, and that thirty percent calcium is most effective. Beyond thirty percent, it is difficult to combine the calcium and the food product, and it is also more difficult to present a compound attractive to the target rodent.

Research has demonstrated that ingested calcium is liquefied in a rodent's gut and absorbed into the blood stream at a rate that is much greater than other mammals. Rodents are also unable to metabolize calcium. The calcium is filtered from the blood stream by the liver and kidneys and accumulates in those organs. Continued ingestion results in the calcification of vital organs and, eventually, the death of the rodent. Research also indicates that the lining of the uterus also becomes calcified in female rodent species, making it impossible for fertilized eggs to implant. This renders female rodents sterile and prevents reproduction prior to the death of the rodent from the calcium infused food product, thereby limiting future generations.

Attractants may be added to the calcium infused food product to make it more desirable to the target rodent. It has been found that sweets, such as powdered sugar (confectioner's sugar), brown sugar, molasses or other sweeteners will cause rodents to ingest more of the calcium infused foodstuffs, resulting in faster mortality.

The food product is formulated to attract a specific, target rodent. The food is intended to be consumed at the bait station or carried back to the nest. There are dietary similarities between rodent species but the targeted formula enhances its attraction to the particular nuisance rodent for which it is intended. The food product is specially selected to resist spoilage, to be harmless to human or non-target animals and environmentally safe.

The food product is lightly coated with an oil derived from a vegetable, seed or nut in the target rodent's diet. The oil is intended to create an olfactory draw to the product and substantially increases the quantity of calcium carbonate that adheres to the food product. The rodent will lick the oil and the attendant calcium carbonate off of some of the discarded seed shells from the food product thereby increasing the intake of calcium carbonate.

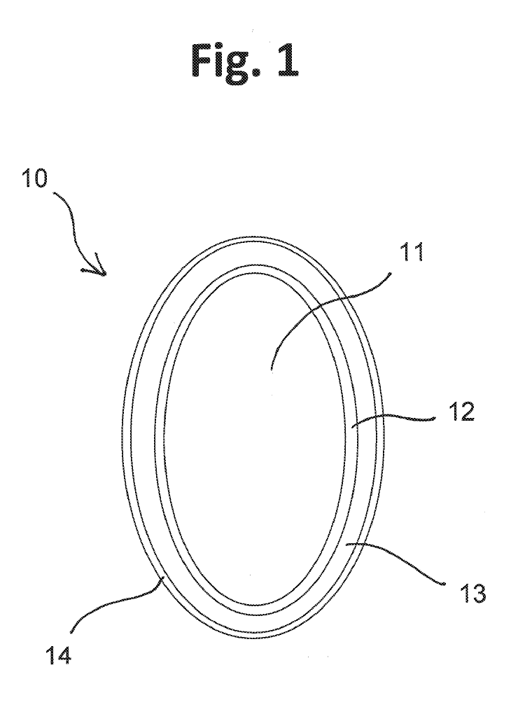

By way of example, kernels of wheat are a favorite food of voles. Referring to FIG. 1, the compound 10 infuses a wheat kernel 11 with calcium carbonate 13 so that the infused kernel has at least twenty percent calcium, by weight, of the combined kernel 11 and calcium 13 compound 10. Edible vegetable, seed or nut oil 12 may be sprayed onto the kernels so that finely powdered calcium carbonate will adhere. After an initial layer of calcium 13 has reached the capacity of the oil 12 to adhere the calcium to the kernel 11, such that additional calcium carbonate will not adhere to the kernel, more oil can be sprayed onto the calcium infused kernel 10, so that more calcium carbonate may be added. A attractant layer 14, such as a sweeter, may also be applied, which will increase the rodent's attraction to the kernels and the calcium surrounding the kernel itself.

The range of food stuffs that can be used as bait include all components of commercially available bird seed, including white millet, cracked corn, nijer seed (also known as thistle seed), the full range of edible nuts commonly consumed by humans including peanuts, almonds, walnuts, etc., commercially available grass seed such as blue grass as long as it is not pretreated, foodstuff such as granola and the wide range of foods consumed by humans, their pets and domesticated animals comprised largely of grain products including virtually all commercially available dry pet foods and equine/cattle foods.

This invention can be used to eradicate mice and rats from the home with complete safety for adults, children and pets. It can be used in garages, shops, barns, and vehicles where mice or rats are a problem. It can be used in agricultural settings such as dairies and grain storage facilities. Because the active ingredient, calcium carbonate, is certified organic, it may be used in all phases of agricultural production, both traditional and the now-emerging organic farming construct.

The invention is useful in controlling vole infestations and the damage they cause, a problem of significance to agriculture, since voles infest in large numbers and are difficult to control, even with conventional methods. Similarly, the invention is an effective and safe chemical control for gophers, especially in use among growing crops, where conventional methods create additional problems.

The potential benefits of a safe and effective rodent control in urban areas, squalid living environments, island habitats and other locations where non-native rodent species have been introduced and cause untold damage and disease is practically limitless.

The description set forth here represents only some embodiments of the invention. After considering these, skilled persons will understand that there are many ways to make a calcium infused compound targeted for consumption by specific rodent species according to the principles disclosed. The inventor contemplates that the use of alternative bait, adherents, attractants, or application techniques, which result in a calcium infused compound according to the principles disclosed, will be within the scope of the invention.

I claim:

1. A calcium infused compound for exterminating rodents comprising a food product attractive to a target rodent species, wherein the food product is infused with calcium so that the calcium is at least twenty percent of a combined weight of the food product and calcium.

2. The calcium infused compound for exterminating rodents of claim 1 wherein the calcium is at least thirty percent of the combined weight.

3. The calcium infused compound for exterminating rodents of claim 1 wherein the calcium is between twenty-five and thirty-five percent of the combined weight.

4. The calcium infused compound for exterminating rodents of claim 1 wherein the calcium is selected from the group consisting of calcium carbonate and calcium bicarbonate.

5. The calcium infused compound for exterminating rodents of claim 3 further comprising an edible oil applied to the food product, wherein the oil adheres the calcium to the food product.

6. The calcium infused compound for exterminating rodents of claim 5 wherein the edible oil is attractive to the target rodent species and selected from a group of edible oils consisting of vegetable, seed and nut oils.

7. The calcium infused compound for exterminating rodents of claim 6 further comprising a sweetener attractive to the target rodent.

8. The calcium infused compound for exterminating rodents of claim 6 wherein the target rodent species is mice and the food product is sunflower seeds.

9. The calcium infused compound for exterminating rodents of claim 6 wherein the target rodent species is voles and the food product is kernels of wheat.

10. A rodenticide consisting of a food product attractive to a target rodent species, an adherent, and calcium, wherein the calcium is adhered to the food product by the adherent, and wherein the calcium is at least twenty percent of the combined weight of the food product and calcium.

11. The rodenticide of claim 11 wherein the calcium is between twenty-five percent and thirty-five percent of the combined weight of the food product and calcium.

12. The rodenticide of claim 11 wherein the calcium is finely powdered calcium carbonate and the adherent is an edible oil attractive to the target rodent species.
